(19) United States
(12) Patent Application Publication
(10) Pub. No.: US 2006/0014607 A1
(43) Pub. Date: Jan. 19, 2006

(54) Operating unit with a steering column selector lever

(76) Inventor: Wolfgang Schweer, Neu Wulmstorf (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 10/893,740

(22) Filed: Jul. 16, 2004

(51) Int. Cl. B60K 41/20

(52) U.S. Cl. 477/96

(57) ABSTRACT

In an operating unit for a motor vehicle power transmission including a shift selector lever a first guide member with a guide slot arrangement is connected to the steering column shift lever for movement therewith and has a first guide path and a second guide path extending at an angle from the first guide path and including a locking location and a release location, and a blocking member of an electrically actuated magnet is arranged at the jointure of the first and second guide paths for blocking access to the first guide path to a locking member extending into the guide paths when an ignition lock is not activated whereby the shift lever is mechanically prevented from being placed into a position permitting any movement of the vehicle.

### BACKGROUND OF THE INVENTION

The invention relates to an operating unit with a steering column selector lever for an automatic vehicle power transmission wherein the lever is movable at least between a Park position and a Drive position guided by a guide structure which provides for a locking position and a release position.

U.S. Pat. No. 3,942,614 discloses already an operating mechanism disposed near the steering column of a motor vehicle with a pivotable shift lever wherein the shift lever is movable between a parking position, a reverse position, and a drive position. By actuating the brake pedal, a piston of a linear actuating magnet can be engaged, but is disengaged upon release of the brake pedal. When the piston is disengaged, the shift lever cannot be moved into Park position if, at that time, it is in the Drive position since an arm connected to the shift lever is blocked by the piston. If the shift lever is at that point in the P (Park) position, it cannot be moved into the D (drive) position when the piston is engaged since the piston, again, blocks the arm of the shift lever. In order to overcome the blocking, it is necessary to step on the vehicle brake. As a result, the shift lever can be moved to the P position during vehicle operation only when the brake is actuated. Furthermore, when the vehicle is at a standstill with the engine running the shift lever is locked in the P position so that the vehicle cannot be unintentionally operated by movement of the shift lever.

It is the object of the present invention to provide a simple operating unit disposed adjacent the steering column and including a pivotable shift lever, wherein the shift lever cannot be moved into D as long as the ignition key is not inserted or, respectively, not moved to the “on” position and, at the same time the brake is actuated.

### SUMMARY OF THE INVENTION

In an operating unit for a motor vehicle power transmission including a shift selector lever a first guide member with a guide slot arrangement is connected to the steering column shift lever for movement therewith and has a first guide path and a second guide path extending at an angle from the first guide path and including a locking location and a release location and a blocking member of an electrically actuated magnet is arranged at the jointure of the first and second guide paths for blocking access to the first guide path to a locking member extending into the guide paths when an ignition lock is not activated whereby the shift lever is mechanically prevented from being placed into a position permitting any movement of the vehicle.

An advantage of the operating unit near the steering column with a pivotable shift lever is that, in contrast to center console shift levers, space is provided in the area of the center console which space can be utilized for example for providing a cup holder which, in some markets such as the US market, is considered by the customers to be an important selling point. In addition, the arrangement has ergonomic advantages over a center console shift lever.

Another advantage is that the shift lever can be mechanically locked in the P position by the insertion of the ignition key or by turning the key to the “ignition on” position. In this way, no electric motor or electromagnetic components are needed. Mechanical components ensure operability of the locking mechanism even upon failure of the onboard electric power supply. The locking is achieved by way of a guide slot structure which comprises at least a first pivotable guide member and a second movable or pivotable guide member. One of the two guide members is preferably a guide slot metal sheet or panel whereas the other guide member may be an arm with a pin extending into the guide slot. The first guide member is firmly connected to the shift lever such that the pivot axis of the shift lever is advantageously at the same time the pivot axis of the first guide member of the guide slot guide structure. The second guide member is movable into a locking position and a release position which movement can be blocked by the ignition lock. By this blocking or locking of the second guide member also the movement of the first guide member can be locked so that the shift lever connected to the first guide member is also locked in the P-position.

When now the first guide member is released by the ignition lock, that is, when it is movable, the shift lever is still in the P position wherein pivoting of the shift lever out of the P position is still blockable by an electric control member, whose position is dependent on the state of a vehicle brake. Consequently, the shift lever can be moved out of the P-position advantageously only upon actuation of the vehicle brake, so that the vehicle cannot be moved unintentionally. Since this control member operates electrically, particularly by an electric motor or an electromagnet, additional conditions may be provided for the operation of the control member. These additional conditions can be set—depending on the electric system of the vehicle by hard wiring or by a programmable data bus system.

The mechanical connection between the second guide member and the ignition lock can be provided in a particularly advantageous manner by means of:
a small gearing
a lever arrangement, or
a guide slot structure.

In a particularly advantageous way, the second guide member may also be provided with a pivot shaft. Then the two pivot shafts of the guide members may be arranged in parallel. In this way, the two guide members may be made pivotable in two only slightly spaced planes which facilitates a very flat design for the operating unit adjacent the steering wheel. Under certain conditions, the two guide members may even be disposed in a common plane.

Between the locking position and the release position, the one guide member does not need to be firmly guided with respect to the other guide member. However, a firm guiding would have its advantages.

Preferably, the shift lever module is a compact unit encapsulated into a module housing which forms a unitary structure with the ignition lock housing. In such an arrangement, the ignition-lock is advantageously disposed close to the components needed for the locking of the shift lever in the P-position so that the common ignition lock module housing can be very small and easily accommodated within the steering column covering.

Further advantages of the invention will become apparent from the following description of a preferred embodiment of the invention on the basis of the accompanying drawings.

### BRIEF DESCRIPTION OF THE DRAWINGS

FIG. 1 shows a steering column gear shift lever module with a shift lever which is in a P-position and an ignition lock without a key inserted and a guide structure in a locking position,

FIG. 2 shows the arrangement of FIG. 1 with a key inserted into the lock and turned to a position “ignition on” but the brake not actuated and the guide structure in a release position,

FIG. 3 shows the guide structure in the D position, and

FIG. 4 shows the paths or angles of movement of various components of the steering column shift lever module of FIGS. 1 to 3.

### DESCRIPTION OF A PREFERRED EMBODIMENT

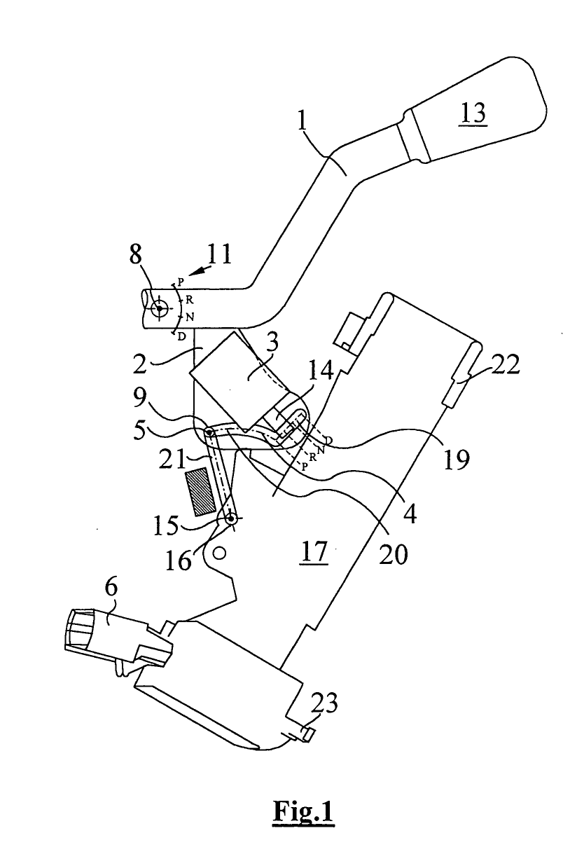

FIG. 1 shows a steering column shift lever module which is arranged close to a steering column which is not shown. With this steering column shift lever module, the driving ranges of an automatic power transmission can be selected. The various components of the steering column shift lever module are firmly connected to a vehicle body or respectively a console. The steering column shift lever module includes a steering column shift lever 1. One end of the steering column shift lever 1 extends through a slot of a steering column cover. The steering column shift lever 1 is disposed in a plane behind the steering wheel. At that end of the steering column shift lever 1, the lever is provided with a shift lever knob 13 by way of which a driver can pivot the steering column shift lever 1 about a pivot axis 8, which is disposed within the steering column covering. At the other end of the steering column shift lever 1, which is not shown, a Bowden cable is connected which extends to a range selector shaft of an automatic power transmission. As a result, pivot movements of the steering column shift lever 1 about the pivot axis 8 are transmitted by the Bowden cable for adjusting the automatic transmission to the various transmission operating or, respectively, driving ranges 11:
“Parking”
“Reverse driving”
“Neutral” or, respectively, idling ignition lock module housing 17 is connected to a cable system by way of a lever arrangement which is not visible in the figure. The cable system is connected within the ignition lock module housing 17 with an ignition lock 6 in such a way that the release arm 21 is locked or blocked in the shown position as long as the ignition key is not inserted or respectively is still in an “ignition off” position.

The ignition lock module housing 17 forms a complete construction unit which, at the end opposite to the ignition lock 6, is engaged in a support structure 22. Between the ignition lock 6 and the pivot shaft 15, the ignition module housing 17 includes a circular opening through which a screw (not shown) extends which is screwed to the vehicle body. By way of this screw
forces, which upon faulty operation of the steering column shift lever 1 and
forces, which as a result of the operation of the ignition key,

are transmitted to the ignition lock module housing 17 are directly transmitted to the vehicle body. In addition, the ignition lock module housing 17 includes at the end where the ignition lock 6 is arranged, engagement tongues 23 which are inserted into receivers in the steering column covering for engagement therewith.

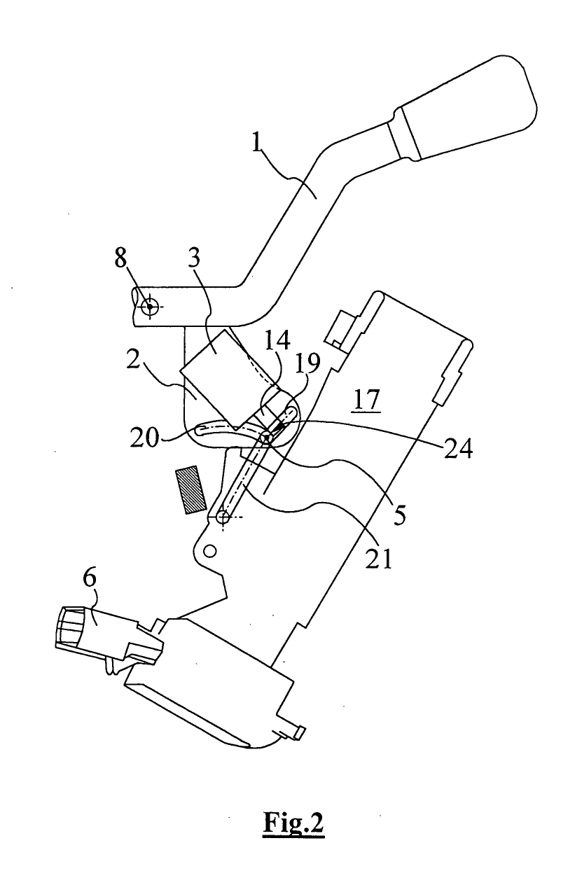

FIG. 2 shows the steering column shift lever module wherein the shift lever 1 is also in the P position. In the state as shown in FIG. 2, however, the ignition key is inserted into the ignition lock 6 but the brake is not yet actuated.

As a result of the insertion of the ignition key and the subsequent turning of the ignition key to the position “ignition on”, the cable system moves the release arm 21 into the release position as shown. The release arm 21 then, by turning the ignition key by hand, is pivoted about the angle 18 shown “Drive” or respectively, forward driving.

which are provided at the automatic transmission as engaged pivot angle positions of range selector shaft of the automatic transmission.

Herein, the transmission setting “Parking” corresponds to a P position, the driving range setting “Reverse driving” corresponds to a R position, the transmission setting “Neutral” corresponds to an N position, and the driving range setting “Drive” corresponds to a D position of the steering column shift lever 1.

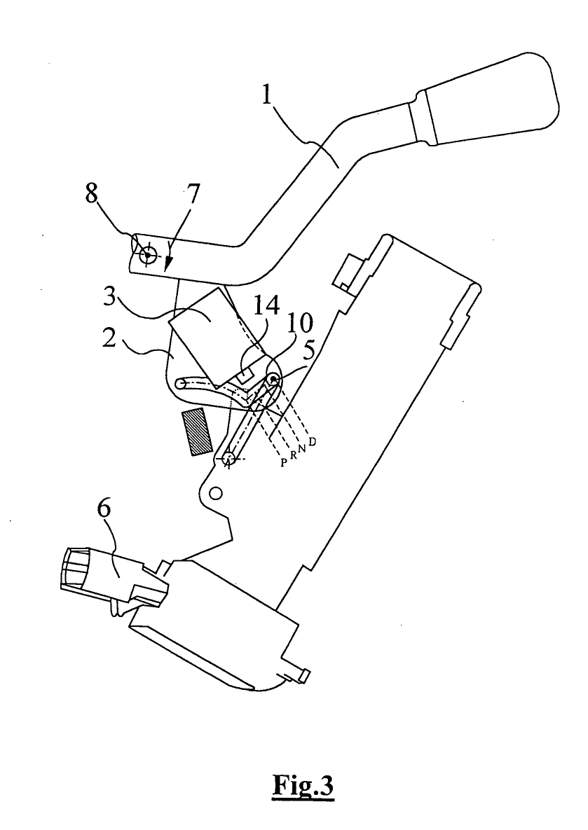

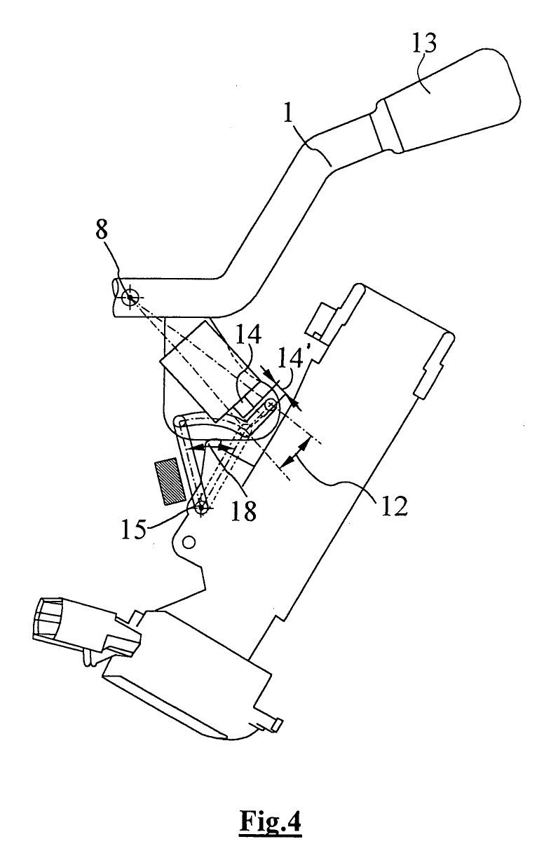

Between the shift lever knob 13 and the pivot axis 8—but closer to the latter—a metal guide plate 2 is welded to the steering column shift lever 1 and a cylinder of an actuating magnet 3 is mounted to the guide plate 2. A piston 14 of the actuating magnet 3 extends in the released position of the piston 14 as shown in FIG. 1 over a guide slot 4 of the guide plate 2 so that the path of movement of a pin 5 in the guide slot 4 is blocked by the piston 14. The guide slot 4 has the shape of two successive curved paths 19 and 20. The first curved path 19 has a large radius whose center point is disposed on the pivot axis 8 of the shift lever 1. The second curved path 20 has a smaller radius with a center point of curvature disposed on a pivot shaft 15 where the release arm 21 is pivotally supported. At its end opposite the pivot shaft 15, the release arm 21 carries the pin 5, which extends into the guide slot 4 and is guided thereby. In the P position shown, the pin 5 is disposed at one end 9 of the guide plate slot 4 in the area of the second curved path 20 when the ignition key is not operated. The position of the pin 5 at the one end 9 of the guide slot 4 is the locking position. The pivot shaft 15 of the release arm 21 is formed by a pivot stub 16 which extends through a round opening of an ignition lock module housing 17 wherein one axial end of the pivot stub 16 within the in FIG. 4 so that the pin 5 is disposed in the area of jointure between the two curved paths 19 and 20. This area of jointure is designated the release position 24. The first curved path 19 however is blocked for the pin 5 by the piston 14 of the linear actuating magnet 3. The piston 14 of the linear actuating magnet 3 can be retracted by actuating the brake pedal for example by stepping onto the brake pedal as will be explained further below in connection with FIG. 3.

The first curved path 19 has a very large radius so that the centerline of the curved path is essentially a straight line. This quasi-straight line is in alignment with the longitudinal axis of the release arm 21 whereas the centerline of the second curved path 20 extends in the area of jointure 24 of the curved paths essentially normal to the longitudinal axis of the release arm 21. With this arrangement of the two curved paths 19 and 20 relative to the release arm 21, easy operation and stability of the system are ensured. Selection forces which, with faulty operation, that is, during an attempt at pivoting the steering column shift lever 1 from the P-position to the R-position without actuation of the brake—are transmitted by way of the blocking piston 14 and the pin 5 to the release arm 21, do not generate a torque in the pivot pin 16. Consequently, not only the release arm 21 is kept free of bending movements and only subjected to pressure forces but also the whole lever arrangement within the ignition lock module housing 17 is kept free for forces. As a result, the lever arrangement can be small and lightweight and inexpensive to manufacture. In the state as shown in FIG. 2, the lever arrangement prevents the removal of the ignition key as long as the release arm 21, or respectively, the pin 5 is not in the locking position which is illustrated in FIG. 1.

When now the brake is operated for example by stepping onto the brake pedal, the piston 14 is pulled back so that the path of the pin 5 along the first curved path 19 is opened as it is shown in FIG. 3.

FIG. 3 shows the steering column shift lever 1 in the D position. To this end, the steering wheel column shift lever 1 has been moved by the driver in the direction of arrow 7 from the P position by way of the R position and the N position to the D position. In the D position, the pin 5 abuts one end 10 of the guide plate slot 4 in the area of the first curved path 19. The selector forces, which, during faulty operation attempts, that is, with an attempted pivoting of the steering column shift lever 1 in the pivot direction 7 beyond the D position, are transferred by way of the pin 5 to the release arm 21, do not generate torsion forces in the pivot stub 16 which is a further advantage in addition to the advantages already described.

FIG. 4 shows:
the angle of operation 18 of the release arm 21,
the engagement or disengagement path 14′ of the piston 14 and the pivot angle 12 of the steering column shift lever 1 about its pivot axis 8.

While the release arm 21 moves through the pivot angle 18 the steering column shift lever 1 is in a still position. It is therefore clear that, in alternative embodiments, the curved path 20 could be eliminated. For the pin 5, only the possibility of locking the steering column shift lever 1 without the need for electric power in a locking position, here at the end 9 of the slot 4 and the existence of a release position 24 with an electrically lockable guide structure—here the first curved path 19—are necessary for functioning. The guide means must include at least a Parking (P)-position and a Drive position (D) in the end areas of the guide means.

The steering column shift lever 1 is placed into the R position and the N-position as it is shown in FIG. 3 for the placement of the steering column shift lever 1 into the D position, although this is not shown in the figures. The linear actuating magnet 3 is provided with an integral coil compression spring which is not shown but which moves the piston 14 inwardly during a fault, that is, if the voltage drops, so that the driver of the vehicle will still be able, at any time, to move the steering column shift lever safely into the P position. The steering column shift lever 1 is held in the four positions P-R-N-D by way of a detent engagement structure of the automatic power transmission wherein the retaining force of the engagement structure can be overcome by the normal operating forces applied at the hand shift knob 13.

In an alternative embodiment of the invention, a detent engagement structure is integrated into the steering column shift lever module. This engagement structure may be arranged at the steering column shift lever or, particularly on the guide slot plate.

The operation wherein the piston is retracted as a result of the actuation of the brake by stepping on the brake pedal can also be achieved in connection with an automated brake. Such an automated brake may for example be an electro-hydraulic or a purely electrical brake. In that case, the operation “Stepping on Brake Pedal” required from the driver for the release of the positions R-N-D is not necessary.

The signal transmission between the brake pedal or, respectively, the automated brake and the linear magnet can be achieved for example by a cable structure which is specifically provided for that function. It is also possible to utilize a signal transmission line which transmits serially or in parallel, additional information. With this signal transmission line also other information can be transmitted for example whether the steering column shift lever is in
the P-position
the R-position
the N-position, or
the D-position.

In this connection, the signal transmission between the steering column shift lever and the automatic transmission may be a so-called “shift-by-wire” system instead of an operating cable arrangement. With such a “shift by-wire” steering column shift lever module, the steering column shift lever includes an electrical or an opto-electronic signal transmitter. The signal transmitter may be arranged at any location of the steering column shift lever, that is, also between the shift knob and the pivot axis of the steering column shift lever, particularly on the guide slot plate.

In another alternative embodiment, the piston may be so designed that it cannot rotate with respect to the cylinder of the linear magnet wherein the piston is slanted at one side thereof which faces the D-position. The linear magnet is then provided with an integral spring which biases the piston into a disengaged position. As a result, under fault conditions when power supply to the linear magnet is interrupted the steering column shift lever can be moved once from the D-position, the N-position or the R-position to the P-position but movement back into one of the positions R-N-D is blocked. As a result, the driver can safely park the car upon loss of the voltage or with a total collapse of the electrical system.

In another embodiment, the linear magnet forms an additional blockage which prevents an unintended switching from the D-position to the R-position or, respectively, the P-position when the vehicle speed is above 10 km/hr.

In place of a linear magnet, an electric drive motor may be provided. This motor may be so arranged that its axis of rotation extends essentially parallel to the longitudinal axis of the release arm in the release position thereof. The drive shaft of the drive motor may be for example a slotted or half-moon shaped disc wherein the slot forms the opening through which the pin of the release arm extends. The return spring for a fault occurrence is in this case a leg spring.

In still another embodiment of the invention, the positions of the release arm and of the guide slot plate are reversed. That is the guide slot plate is mechanically connected to the ignition lock in such a way that turning of the ignition key out of the position “ignition off” results in pivot movement of the guide slot plate. In contrast, the release arm or the respective functional component, specifically the pin guided by the slot in the slot guide plate, is firmly connected to the steering column shift lever.

In order to reduce the number of components, in another embodiment it is also possible to guide the rod of the steering column shift lever directly in a guide slot of the guide slot plate.

Instead of the pivot movement of the guide arm or the pin mounted thereon, other designs may be used wherein the pin is moved along a straight line.

The automatic power transmission operated by the steering column shift lever may be
a planetary automatic transmission,
an infinitely variable transmission such as a toroidal transmission,
a belt type transmission, or
an automated overdrive transmission such as a double clutch transmission.

The embodiments described are only exemplary embodiments. A combination of the features described for different embodiments is also possible. Additional features of the invention, which have not been described, are apparent from the arrangements shown in the drawings.

What is claimed is:

1. An operating unit for a motor vehicle power transmission including a steering column shift selector lever (1) which is movable at least between a Park position (P) and a Drive position (D), a guide slot structure including a first guide member (guide slot plate 2) connected to said steering column shift lever (1) for movement therewith, said first guide member guide slot structure having a locking position (9) and a release position (24) and including a first guide path (slot 19) extending from said release position, an electrically actuated blocking member (14) (of linear magnet 3) arranged so as to be capable of blocking said first guide slot (19) said blocking member (14) being operable depending on the state of a vehicle brake, and an ignition lock (6) including an operating mechanism with a second guide member (5) received in said guide slot (19, 20) and being mechanically connected to the ignition lock (6) such that, by a change of the position of an ignition key in the ignition lock, the second guide member (5) is moved from the blocking position to the release position (24).

2. An operating unit for a motor vehicle power transmission according to claim 1, wherein the electrically operated blocking member (3) comprises a cylinder and a piston (14) said cylinder being connected to the steering column shift lever (1) and said piston (14) extending into the guide slot (19) for blocking the first guide path (19).

3. An operating unit for a motor vehicle power transmission according to claim 1, wherein blocking the first guide slot (19) the ignition lock (6) is arranged within an ignition lock module housing (17) within which also a mechanical connection (lever arrangement with cable operating system) with the second guide member (pin 5) is arranged, said ignition module housing being firmly mounted on a vehicle body.

4. An operating unit for a motor vehicle power transmission according to claim 1, wherein one of the two guide members (2, 5) comprises a guide pin (5) which is guided by the second curved path (20) which extends from the locking position (9) to the release position (24), the second curved path (20) having a center of curvature which is formed by a pivot axis (15) about which the second guide member (5) is pivotally supported.

5. An operating unit for a motor vehicle power transmission according to claim 1, wherein the center of curvature of the first curved path (19) extending from the second curved path (20) is disposed on the center axis (8) of the steering column shift lever (1).

6. An operating unit for a motor vehicle power transmission according to claim 1, wherein the first curved path (19), after the release position (24) includes for the second guide member (5),
a R position corresponding to reverse driving,
an N-position corresponding to “Neutral”, and
a D position corresponding to forward driving of the vehicle.
